(19) United States
(12) Patent Application Publication
(10) Pub. No.: US 2005/0038934 A1
(43) Pub. Date: Feb. 17, 2005

(54) USB-based peripheral device and method for starting up the USB-based peripheral device

(75) Inventors: Ralf Gotze, Munchen (DE); Christian Schneckenburger, Hohenkirchen (DE); Kalman Cinkler, Munchen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/915,258

(22) Filed: Aug. 9, 2004

(30) Foreign Application Priority Data
Aug. 11, 2003 (DE) 103 36 877.9

(51) Int. Cl. G06F 3/00

(52) U.S. Cl. 710/15

(57) ABSTRACT

USB-based peripheral device for operation with a host system, having a driver for operation with the host system, wherein the driver is stored in a memory in the USB-based peripheral device, and with startup of the peripheral device on the host system, prompting automatic installation of the driver on the host system.

### CROSS-REFERENCE TO RELATED APPLICATION

This application claims priority to German Patent Application No. 103 36 877.9 filed Aug. 11, 2003, and is incorporated herein by reference in its entirety.

### FIELD OF THE INVENTION

The present invention relates to a USB-based peripheral device for operation with a host system and to a method for starting up the USB-based peripheral device on a host system.

### BACKGROUND OF THE INVENTION

Host systems are normally operated with a large number of peripheral devices, such as keyboard, mouse, monitor, printer, scanner, external storage media and internal peripheral devices, such as interface cards or hard disks.

In the field of bus systems which are available today for connecting the peripheral devices to the host system, for example computer systems, the universal serial bus (USB) is becoming particularly important as a simple, universal standardized interface with a high level of scalability. One of the great advantages of the USB is the ability to add or remove peripheral devices during operation.

To achieve the full operability of the peripheral devices, a driver needs to be installed on the host system for each peripheral device.

To allow the drivers within a USB system to be configured as easily as possible, different USB-based peripheral devices are put into the device classes HUB (networks), audio (loudspeaker, microphone), printer, communication (modems), mass storage (hard disks) and human interface device (keyboards, mouse, joystick). The drivers required for these device classes are already included upon delivery of all current operating systems, such as Windows or Linux. When the peripheral device is connected to the USB, the connected peripheral device is identified by the host system using a hardware identifier transmitted by the peripheral device and then the device class is ascertained, said device class being transmitted by the peripheral device using a descriptor which the peripheral device uses in order to notify the host system of its attributes. Using the ascertained device class, the operating system loads the appropriate driver, which is then entered into the registry and can be assigned on the basis of this entry when the peripheral device is connected again in future.

For peripheral devices which do not belong to any of the defined device classes, the driver needs to be loaded from the installation disk or CD. To this end, the driver is loaded onto the host system from an installation diskette or installation CD, which the manufacturer of the peripheral device includes with the delivery, in a separate installation process. Normally, this requires complex user inputs which require a user to have detailed knowledge of the peripheral devices and of the host system. Particularly in environments which change on a mobile basis, for example internet cafes, reinstallation using a diskette or CD is required in each case. Added to this is the problem that a user is not permitted to install software for such publicly accessible systems.

### SUMMARY OF THE INVENTION

An object of the invention is therefore to propose a solution which permits flexible and uncomplicated startup of USB-based peripheral devices on any host system.

This object is achieved by virtue of the driver being stored in the USB-based peripheral device, with startup of the peripheral device on the host system prompting automatic installation of the driver on the host system. The object is also achieved by a method for starting up the USB-based peripheral device in which the peripheral device outputs a descriptor for a device class defining mass storage, the host system integrates the peripheral device as a drive for system access operations, automatically installs a driver stored on the peripheral device in a memory which is associated with the host system, and enters the driver into the registry file in the host system.

By this means, the invention provides a peripheral device which permits simple and very flexible startup of the peripheral device without a user having any system-specific knowledge. The fact that the peripheral device whose device class is not known to the operating system pretends to be a device which is associated with the mass-storage device class allows the peripheral device to be integrated in the device manager of the host system at any time on the basis of the driver which is known to the operating system of the host system, which means that installing the driver required for operating the peripheral device requires no action by the user.

One particular advantage is that the manufacturer does not need to include any installation diskettes or CDs for driver installation with the delivery. This saves process costs, which arise for creating the diskettes or CDs, for storage and for packaging, and material costs.

Advantageously, the peripheral device signs off from the USB again following driver installation, which means that the peripheral device is also erased from the device manager. When the device signs onto the USB again, the operating system is able to take an entry in the registry (which was made following installation) as a basis for assigning the correct driver to the peripheral device, so that the peripheral device is loaded and the application can be started on the peripheral device.

### BRIEF DESCRIPTION OF THE DRAWINGS

The invention is explained in more detail below with reference to the figures shown in the drawings, in which:

FIG. 1 shows a peripheral device based on the invention which is connected to a host system, and

FIG. 2 shows a flowchart of startup of the inventive peripheral device on the host system.

### DETAILED DESCRIPTION OF THE PREFERRED MODE OF THE INVENTION

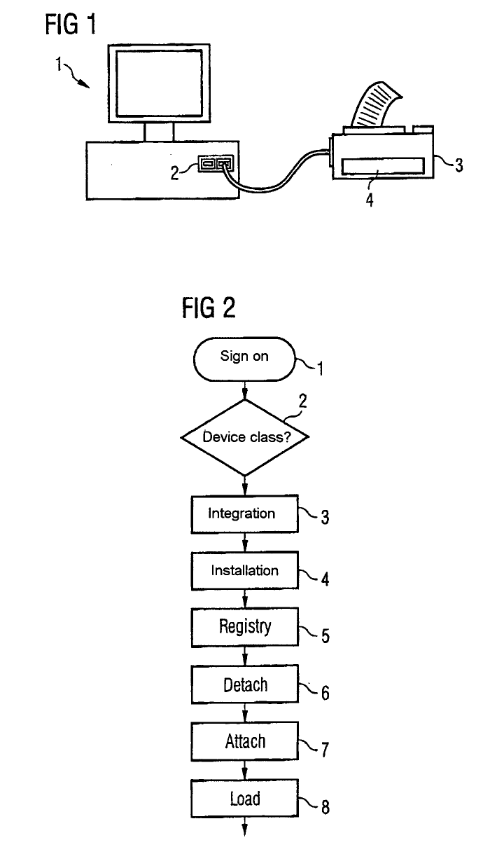

FIG. 1 shows a host system 1 with a peripheral device 3 connected to the host system 1 via a USB interface 2. The peripheral device 3 has a memory 4 storing identification data, such as a hardware identifier or an associated device class, a setup program with driver files and an installation tool for installing the driver on the host system. In this case, the peripheral device is in a form such that it is identified by the host system 1 upon connection to the USB interface 2 and uses a descriptor to transmit its device class to the host system 1. If it is not possible to assign any standardized device class stored in an operating system for the host system 1 to the peripheral device 3, the peripheral device 3 automatically starts the setup program, with the driver files being copied to a hard disk (not shown here) in the host system. The operating system of the host system 1 is used to align a registry, and the driver is integrated using dedicated operating system mechanisms.

FIG. 2 shows the flow when starting up the inventive peripheral device 3 on the host system 1 and the associated installation operation. In a first step 1, a user has connected the peripheral device 3, for example a chip card, to his host system 1. In this context, the chip card transmits its hardware identifier and a mass-storage descriptor to the host system 1 in order to indicate its associated device class. If the operating system of the host system is able to assign the chip card to a device class which is known to it in step 2, it then automatically associates the chip card into, by way of example, a device manager and explorer in the host system 1 as a new drive in step 3, since a driver specified for this device class is known to the operating system. The driver required for operating the chip card and also the setup program for carrying out the installation of the driver on the host system 1 are stored in the memory 4 in the chip card. In step 4, the driver is automatically installed, this involving the driver being stored on the hard disk in the host system 1. In the next step 5, the driver is entered into the registry of the host system 1. In step 6, the chip card integrated as mass storage automatically signs off from the USB. The operating system then removes the chip card from the device manager. In step 7, the chip card signs onto the USB again, in which case the operating system assigns the correct driver to the chip card with an unknown device class, and then loads the appropriate driver in step 8, which means that the chip card can be used to execute a target application.

The inventive peripheral device makes it possible to start up a peripheral device very flexibly and easily on any desired computer system, without making any specific or general user inputs which can be executed only on the basis of special knowledge of the computer system or of the peripheral device. This applies particularly when using publicly accessible computer systems, for which installation of software is normally not permitted.

1. A USB-based peripheral device for operation with a host system, having a driver for operation with the host system, wherein the driver is stored in a memory in the USB-based peripheral device, and with startup of the peripheral device on the host system, prompting automatic installation of the driver on the host system.

2. The USB-based peripheral device as claimed in claim 1, wherein the USB-based peripheral device is an external or internal peripheral device.

3. The USB-based peripheral device as claimed in claim 1, wherein the USB-based peripheral device is a peripheral device with a driver of unknown device class which is necessary for operation.

4. The USB-based peripheral device as claimed in claim 3, wherein the memory in the peripheral device stores an attribute which is associated with a mass-storage device class and which can be output to the host system using a descriptor.

5. A method for starting up a USB-based peripheral device on a host system, comprising the steps of:
the peripheral device outputting a descriptor for a device class defining mass storage when said peripheral device is first connected to a USB interface in the host system;
the host system taking a driver which is available for the mass-storage device class as a basis for integrating the peripheral device as a mass-storage drive for system access operations;
automatically installing a driver stored on the peripheral device on a hard disk associated with the host system; and
entering the driver in the registry file in the host system.

6. The method as claimed in claim 5, further comprising the steps of:
the peripheral device automatically signing off from the host system following driver installation and entry into the registry file; and
the host system removing the integration of the peripheral device as a mass-storage drive.

7. The method as claimed in claim 6, further comprising the steps of the peripheral device signing onto the USB interface again and outputting to the host system a descriptor of unknown device class which is associated with the installed driver.

8. The method as claimed in claim 7, further comprising the steps of the host system automatically assigning the driver required for operating the peripheral device on the basis of the entry in the registry and loading the driver for the purpose of executing a target application.
